(19) United States
(12) Patent Application Publication
(10) Pub. No.: US 2007/0078625 A1
(43) Pub. Date: Apr. 5, 2007

(54) Tool to facilitate safer computer usage of individual users

(76) Inventors: Mark Murphy, Clonee (IE); Thomas P. Mooney, County Kildare (IE); Liam Gannon, Westport (IE); Joshua Painter, Dublin (IE); Stephen McGuirk, Dublin (IE); Brendan J. Cannon, Dublin (IE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/242,168

(22) Filed: Sep. 30, 2005

(51) Int. Cl. G06F 15/00

(52) U.S. Cl. 702/176

(57) ABSTRACT

In one embodiment, a method for facilitating safer computer usage of individual users includes collecting data pertaining to user interactions with a cursor control device and a keyboard, and providing feedback to the user based on the collected data. The feedback concerns the usage of the computing device by the user.

### FIELD

Embodiments of the invention relate generally to data management, and more specifically to facilitating safer computer usage of individual users.

### BACKGROUND

Ergonomic injuries may cause various problems beginning with general aches and pains in wrists, necks, fingers, backs, knees, and feet to joint and tendon infections requiring expensive pain killers or anti-arthritis medications and time consuming physical therapy. In recent years, musculoskeletal disorder (MSD) has been the number one ergonomic injury cause. Various studies suggest a link between a personal computer (PC) volume usage and injury. Hence, correct ergonomic methods for PC usage and management of the volume component are vital in protecting employees from ergonomic MSDs.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a network architecture in which embodiments of the present invention may operate;

FIG. 2 illustrates a block diagram of one embodiment of an ergonomic tool;

FIG. 3 illustrates a block diagram of one embodiment of a computer usage management system;

FIG. 4 is a flow diagram of one embodiment of a process for facilitating safer computer usage of individual users;

FIGS. 5 and 7A are flow diagrams of alternative embodiments of an automated feedback generation process;

FIG. 6 illustrates an exemplary set of taskbar icons;

FIG. 7B illustrates exemplary alerts presented to a user;

FIG. 8 is a flow diagram of one embodiment of a process for providing PC usage statistics and historical data;

FIGS. 9A-9F illustrate exemplary user interfaces used to present PC usage statistics and historical data;

FIG. 10 is a flow diagram of one embodiment of a process for providing centralized management of PC usage data; and

FIG. 11 is a block diagram of one embodiment of a computer system.

### DESCRIPTION OF EMBODIMENTS

A method and apparatus for facilitating safer computer usage of individual users is described. In the following description, for purposes of explanation, numerous specific details are set forth in order to provide a thorough understanding of the present invention. It will be apparent, however, to one skilled in the art that the present invention can be practiced without these specific details.

Some portions of the detailed descriptions that follow are presented in terms of algorithms and symbolic representations of operations on data bits within a computer system's registers or memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer-system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

Although the below examples may describe protection of privacy of networked devices containing management subsystems in the context of execution units and logic circuits, other embodiments of the present invention can be accomplished by way of software. For example, in some embodiments, the present invention may be provided as a computer program product or software which may include a machine or computer-readable medium having stored thereon instructions which may be used to program a computer (or other electronic devices) to perform a process according to the present invention. In other embodiments, processes of the present invention might be performed by specific hardware components that contain hardwired logic for performing the processes, or by any combination of programmed computer components and custom hardware components.

Thus, a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

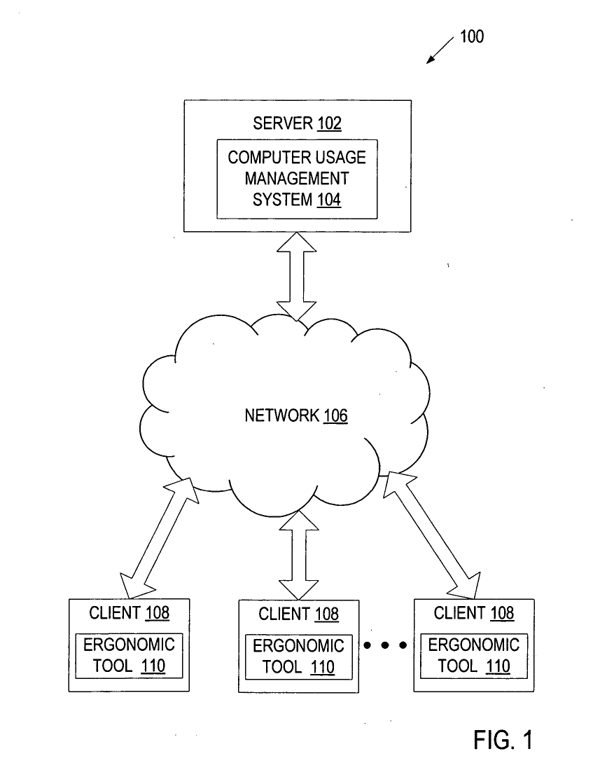

FIG. 1 illustrates an exemplary architecture 100 in which embodiments of the present invention may operate. The architecture 100 may include client devices 108 coupled with a server (or set of servers) 102 via a network 106 (e.g., a public network such as the Internet or a private network such as a local area network (LAN)). The client devices 108 may be, for example, personal computers (PCs), mobile phones, palm-sized computing devices, personal digital assistants (PDAs), etc.

Each client 108 hosts an ergonomic tool 110 that monitors the usage of the client device 108 by its user. In one embodiment, the ergonomic tool 110 collects data pertaining to user interactions with the cursor control device (e.g., a mouse, trackball, or stylus device) and the keyboard. The user interactions may include, for example, mouse clicks, mouse movement (e.g., screen activity and pointer movement), keystrokes, etc. Based on the collected data, the ergonomic tool 110 provides feedback to the user. Exemplary feedback may include alerts containing ergonomic recommendations, visual indicators of the user's client device usage pattern, statistics pertaining to the user's client device usage pattern, etc.

The server(s) 102 hosts a computer usage management system 104 that receives user interaction data from the clients 108, stores this data in a centralized database and generates various statistics and reports based on the received data. The statistics and reports provide historical data about the user's client device usage pattern, a comparison of the user's usage pattern with other users and/or groups of users, and other information. In one embodiment, the user interaction data received from the clients 108 is anonymous and does not reveal the identity of their users.

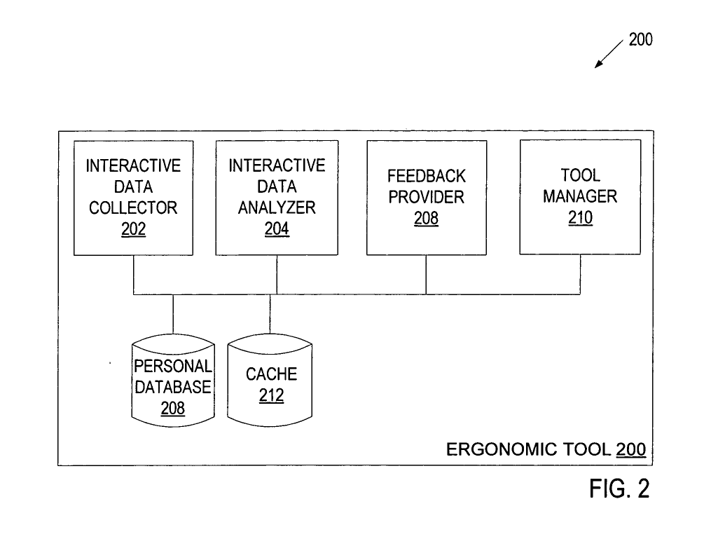

FIG. 2 is a block diagram of one embodiment of an ergonomic tool 200. The ergonomic tool 200 includes an interactive data controller 202, an interactive data analyzer 204, a feedback provider 208, a personal database 208, and a cache 212.

The interactive data controller 202 is responsible for monitoring events initiated by the user interaction with the cursor control device and the keyboard (e.g., mouse clicks, mouse movements, keystrokes, etc.) and recording data characterizing these events in the personal database 208. The data characterizing the events may include, for example, the number of mouse interaction events and the number of keyboard interaction events occurred over a predefine time period, the frequency of the events, applications associated with the events, etc.

The interactive data analyzer 204 is responsible for analyzing the data collected by the interactive data controller 202. In one embodiment, the interactive data analyzer 204 analyzes the collected data using a set of predefined thresholds. As will be discussed in more detail below, when one of the thresholds is met, the interactive data analyzer 204 may inform the feedback generator 206, which then generates a relevant feedback. Each threshold may correspond to specific conditions associated with the user's client device usage. For example, a first threshold may correspond to the user's activity every 30 seconds for 20 minutes, a second threshold may correspond to the user's activity every 30 seconds for 35 minutes, a third threshold may correspond to the user's activity every 5 minutes for 60 minutes, etc.

The feedback provider 208 is responsible for providing various feedback generated based on data collected by the interactive data controller 202 and/or analyses performed by the interactive data analyzer 204. In one embodiment, the feedback provider 208 generates several types of feedback. As will be discussed in greater detail below, the types of feedback may include, for example, alerts containing ergonomic recommendations, visual indicators illustrating the amount of the user's client device usage, statistics pertaining to the client device usage, etc.

In one embodiment, the feedback provider 208 presents to the user icons on the taskbar that visually illustrate the amount of the client device usage. In addition, in one embodiment, the feedback provider 208 may periodically display to the user popup windows containing alerts with ergonomic recommendations. In one embodiment, the feedback provider 208 may also present to the user statistics and historical data associated with client device usage.

The cache 212 stores historical data associated with the user's client device usage. In one embodiment, the cache 212 may also store statistics received from the server. This statistics pertains to the computer usage of this user relative to other users and groups of users.

In one embodiment, the ergonomic tool 200 also includes a tool manager 210 that maintains user preferences pertaining to the ergonomic tool 200. The user preferences may specify whether the user desires to send his or her data to the server and whether the user desires to create or subscribe to work groups to allow for work group level comparisons. In one embodiment, the tool manager 200 also maintains a unique user identifier (UUID). The tool manager 200 sends the information pertaining to the user's subscriptions and work groups to the server.

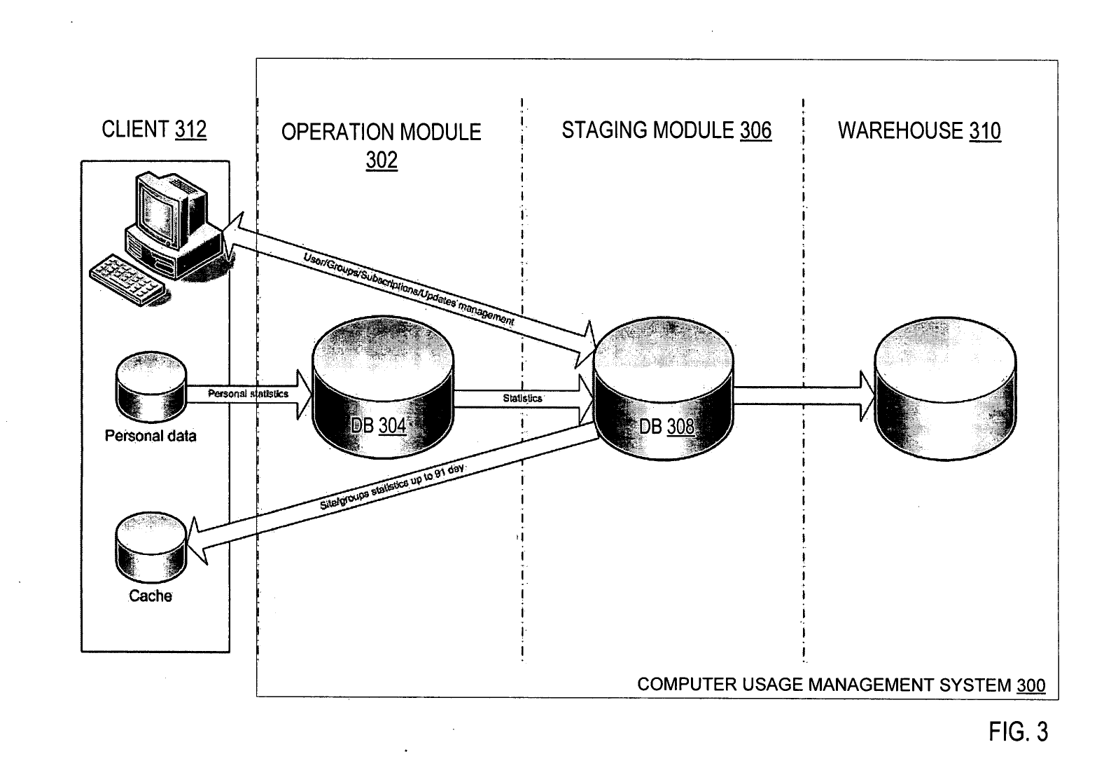

FIG. 3 is a block diagram of one embodiment of a computer usage management system 300. The system 300 includes an operation module 302, a staging module 306 and a warehouse 310.

The operation module 302 receives personal statistics from various clients 312 and stores the personal statistics in a database 304. The personal statistics is received from the clients 312 periodically (e.g., every hour). The personal statistics pertains to the user's client device usage. In one embodiment, the operation module 302 divides the statistics into different groups. For example, the operation module 302 may divide the statistics into a 2-day data group and a recent statistics group.

The staging module 306 receives user preference information from various clients 312. The user preference information may identify users, sites and groups. The staging module 306 also receives statistics from the database 304 and saves it in a database 308. In one embodiment, the staging module 306 divides the statistics into several groups. For example, the staging module 306 may divide the statistics into a today data group (or a 2-day data group to support different time zones), a 25-day data group (data accumulated for the last 25 days from today) and a 75-day data group (the remaining 75-day data of 100-day statistics). In one embodiment, the staging module 306 also sends combined statistics (e.g., site and/or group statistics up to 91 days) to individual client devices 312. The staging module 306 may send the combined statistics to the client devices 312 once a day, as well as less frequently (e.g., once a week) or more frequently (e.g., every hour).

The warehouse 310 receives statistics from the staging module 306 and accumulates historical data (e.g., data necessary to build a 100-day cube and a 2-day cube). In one embodiment, the warehouse module 310 allows individual users to review their client device usage data by UUID. In addition, the warehouse module 310 may allow users to delete all the data relating to their UUID stored in the database.

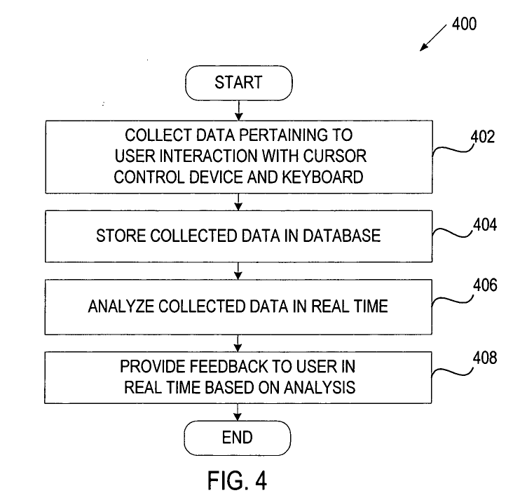

FIG. 4 is a flow diagram of one embodiment of a process 400 for facilitating safer computer usage of individual users. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 400 is performed by an ergonomic tool 110 of FIG. 1.

Referring to FIG. 4, process 400 begins with processing logic collecting interactive data pertaining to user interactions with a cursor control device (e.g., a mouse, trackball, or stylus device) and a keyboard (processing block 402). The user interactions may include, for example, mouse clicks, mouse movements, keystrokes, etc. In one embodiment, processing logic collects interactive data by tracking interactive events initiated by the user interaction with the cursor control device and the keyboard, identifying the occurrence of each interactive event, and determining an application associated with each interactive event. In one embodiment, processing logic also tracks individual character strings within a browser application (e.g., Internet Explorer) or any other interface-based application to allow analysis of the application. This analysis may subsequently be used to make the application more ergonomic friendly. In addition, in one embodiment, processing logic detects and records missed and taken shortcuts by type and application. This information indicates the function of the shortcut and may subsequently be used to form an individual ratio based on the shortcut ratios calculated.

At processing block 404, processing logic stores the collected data in a local database.

At processing block 406, processing logic analyzes the collected data in real time. In one embodiment, processing logic analyzes the collected data by calculating user interaction parameters based on the collected data, and comparing the user interaction parameters with predefined thresholds. User interaction parameters may include, for example, the length of each break (when the user has no interaction with the computing device such as a PC), the number of keyboard interactions between the breaks, the number of mouse interactions between the breaks, time intervals between the interactive events, etc. The predefined thresholds may set specific conditions for a certain combination of user interaction parameters, as will be discussed in more detail below. In one embodiment, processing logic also analyzes the collected data using business rules to determine the data processing activity (e.g., “delete my data”, “unsubscribe” from group, etc.).

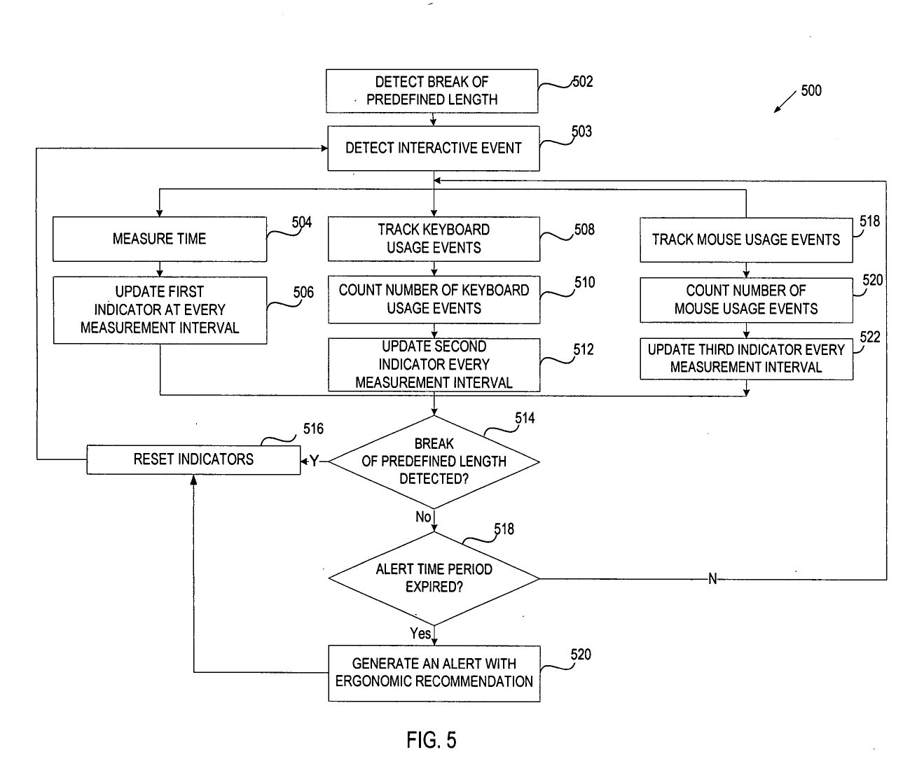

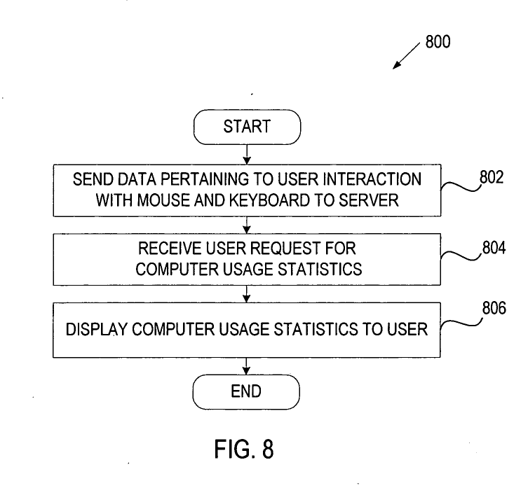

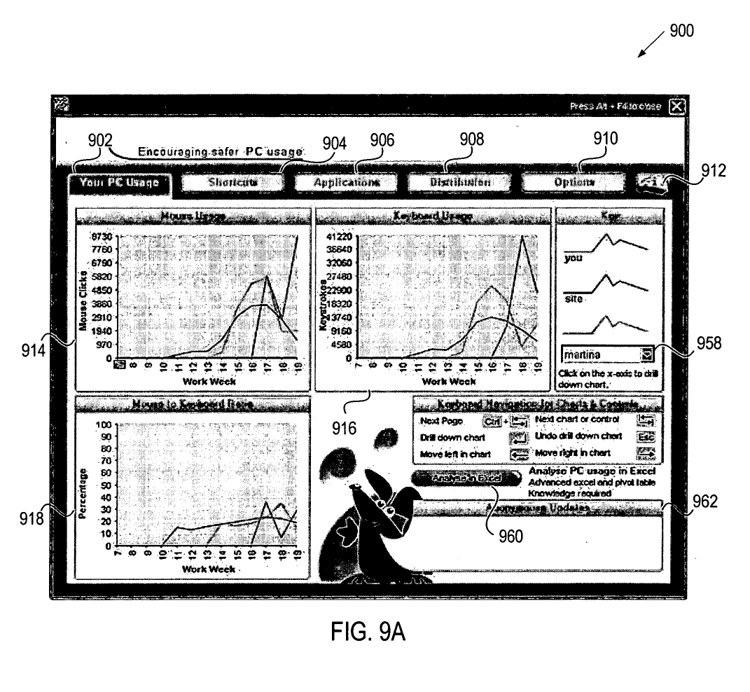

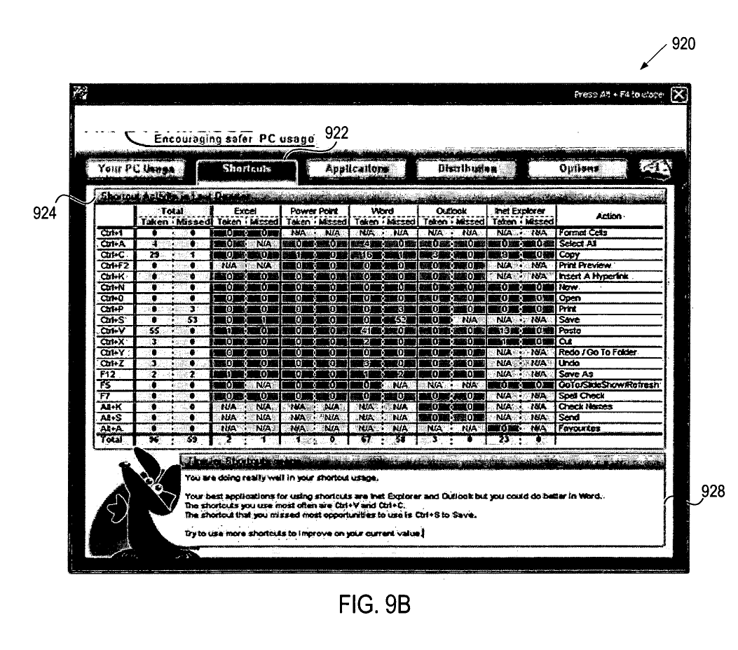

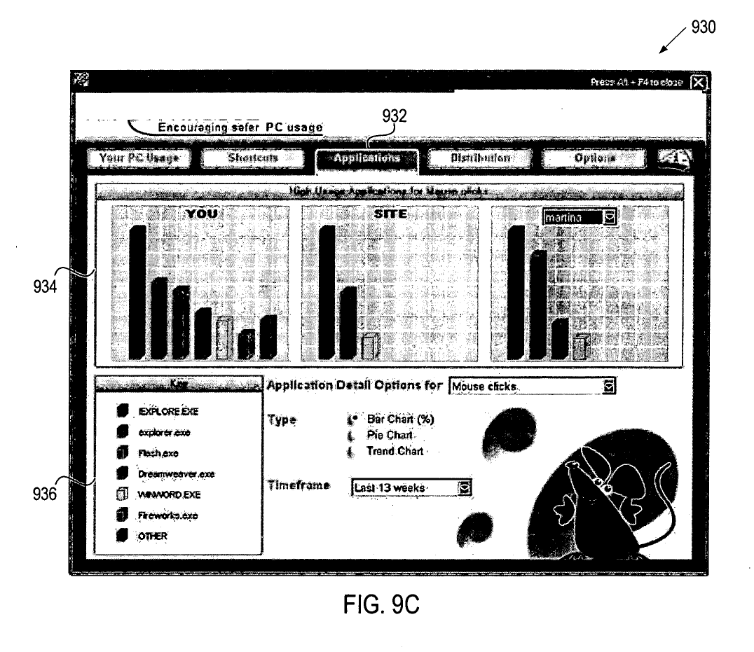

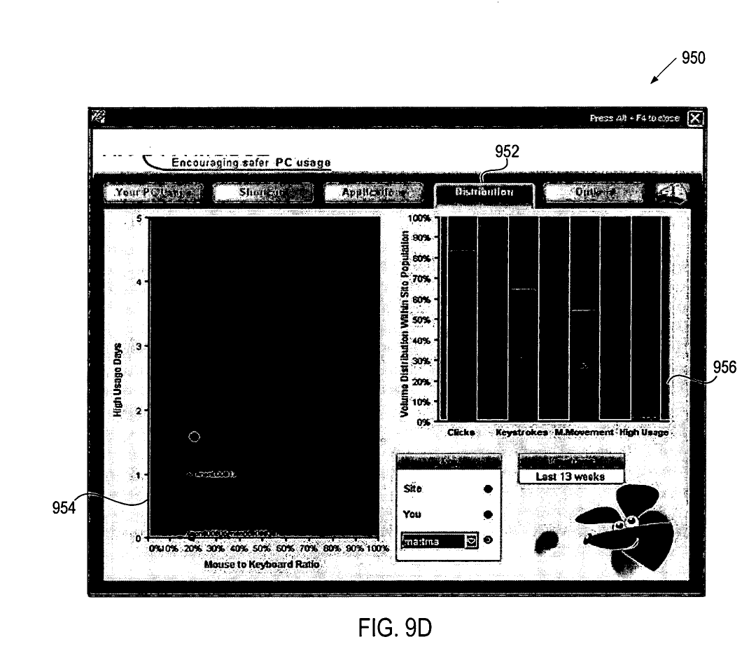

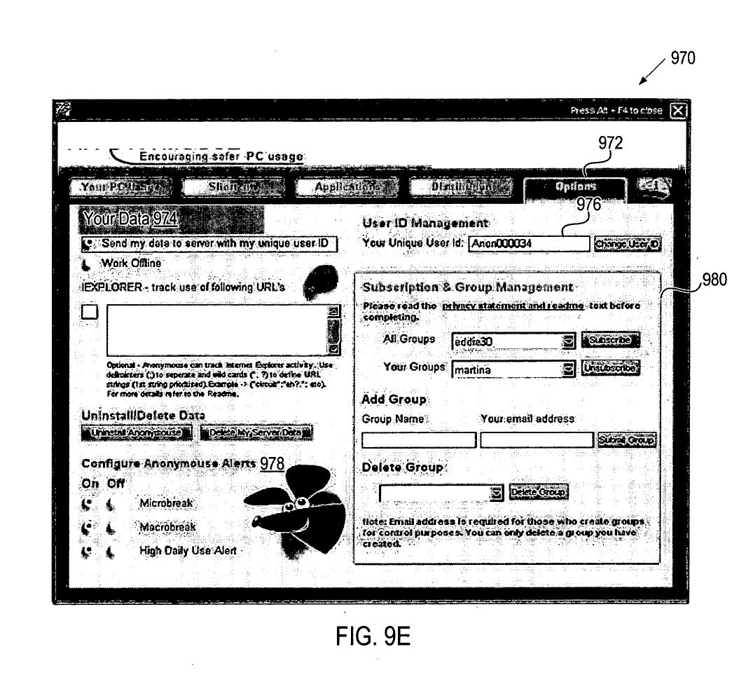

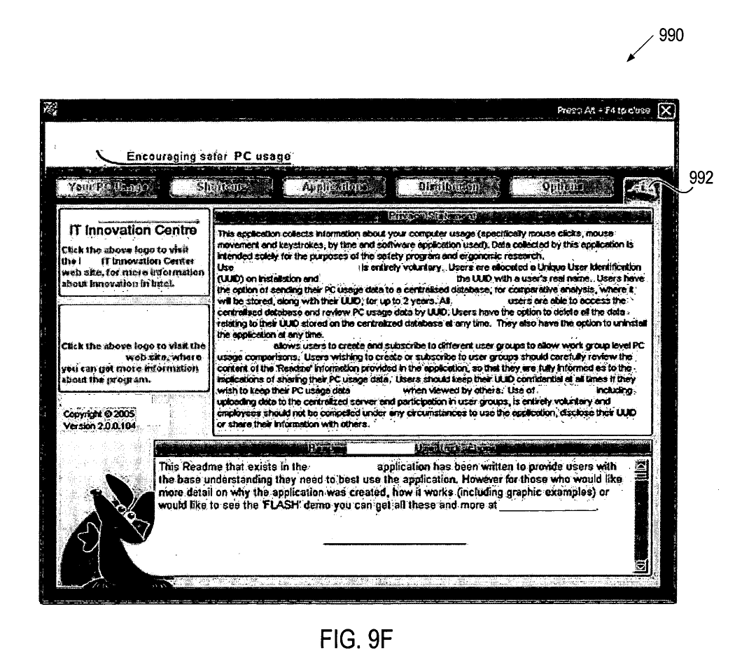

At processing block 408, processing logic provides feedback to the user in real time based on the analyses performed at processing block 406. In one embodiment, feedback is provided automatically when processing logic determines that user interaction parameters met threshold conditions. The automated feedback may include, for example, visual indicators of PC usage and/or alerts containing ergonomic recommendations. Embodiments of an automated feedback process will be discussed in more detail below in conjunction with FIGS. 5-7. In another embodiment, feedback may be provided in response to a user request for statistics and/or historical data, as will be discussed in more detail below in conjunction with FIGS. 8-9.

FIG. 5 is a flow diagram of one embodiment of an automated feedback process 500. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 500 is performed by an ergonomic tool 110 of FIG. 1.

Referring to FIG. 5, process 500 begins with processing logic detecting an overall PC break of a predefined length (processing block 502). In one embodiment, processing logic detects an overall PC break when it does not detect any interactive events for a predefined length of time. As discussed above, the interactive events include user interactions with the mouse and the keyboard.

Once the next interactive event is detected (processing block 503), processing logic begins performing several operations in parallel. In particular, processing logic measures the time (processing block 504) and updates a first indicator at every measurement interval (processing block 506). The first indicator may be presented as a clock that is incremented by a measurement interval (e.g., 5 minutes). The first indicator may be presented in an icon on the taskbar.

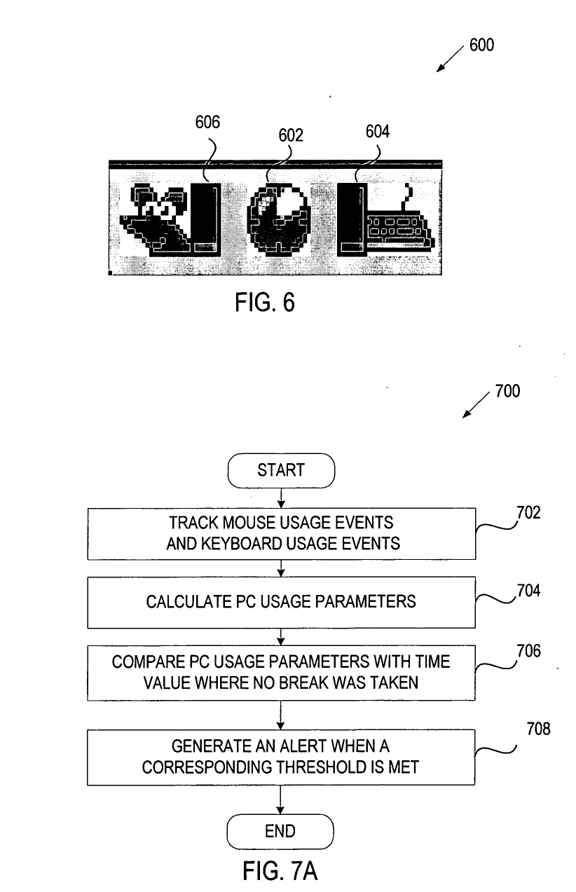

In addition, in parallel with the time measurements, processing logic tracks keyboard usage events (processing block 508) and mouse usage events (processing block 518), and counts the keyboard usage events (processing block 510) and mouse usage events (processing block 520). At every measurement interval, processing logic updates a second indicator based on the current number of keyboard usage events (processing block 512). At the same time, processing logic may also update a third indicator based on the current number of mouse events (processing block 522). The second and third indicators may be presented together with the first indicators in the icons on the taskbar. Exemplary taskbar icons will be discussed in more detail below in conjunction with FIG. 6.

Once processing logic detects an overall PC break of a predefined length (processing block 514), processing logic resets the indicators (processing block 516) and returns to processing block 503. Otherwise, processing logic determines whether an alert time period has expired (processing block 518). If so, processing logic generates an alert with an ergonomic recommendation (e.g., recommendation to take a break) (processing block 520), resets the indicators (processing block 516), and returns to processing block 503. If not, processing logic continues to measure time (processing block 504) and track keyboard usage events (processing block 508) and mouse usage events (processing block 518).

FIG. 6 illustrates an exemplary set of indicator icons 600 on a taskbar. The center icon represents a clock 602. At every measurement interval (e.g., 5 minutes) of PC usage (mouse and/or keyboard activity), the clock 602 increments by 5 minutes revealing an extra portion of exposed yellow elapsed time. If at any time during the hour, the user takes a break of predefined length (e.g., 5 minutes), the clock 602 automatically resets to zero (all blue). If the clock 602 reaches all the way to one hour (has turned fully yellow), then an ergonomic alert is generated as a break reminder. The clock 602 then resets to zero (all blue) whether the user has taken a break or not.

The right hand side icon illustrates the amount of keyboard usage the user has had since the last overall PC break. Every extra 5 minutes of keyboard usage makes the colored indicator 604 grow one pixel taller. A full indicator 604 means that the user has used the keyboard for a full hour since the last PC break, which causes an ergonomic alert to be generated. The full indicator 604 then resets to zero.

The left hand side icon represents the amount of mouse usage the user has had since the last overall PC break. Every extra 5 minutes of mouse usage makes the colored indicator 606 grow one pixel taller. A full indicator 606 means that the user has used the mouse for a full hour since the last PC break, which causes an ergonomic alert to be generated. The full indicator 606 then resets to zero. The mouse usage indicator 606 may also change color. For example, for the first hour of PC usage, the indicator 606 may increment in a green color. After more than one hour of total daily mouse usage, the indicator 606 may increment in an orange color. If the user has had more than 3 hours total mouse usage in a day, the indicator 606 may start to increment in a red color.

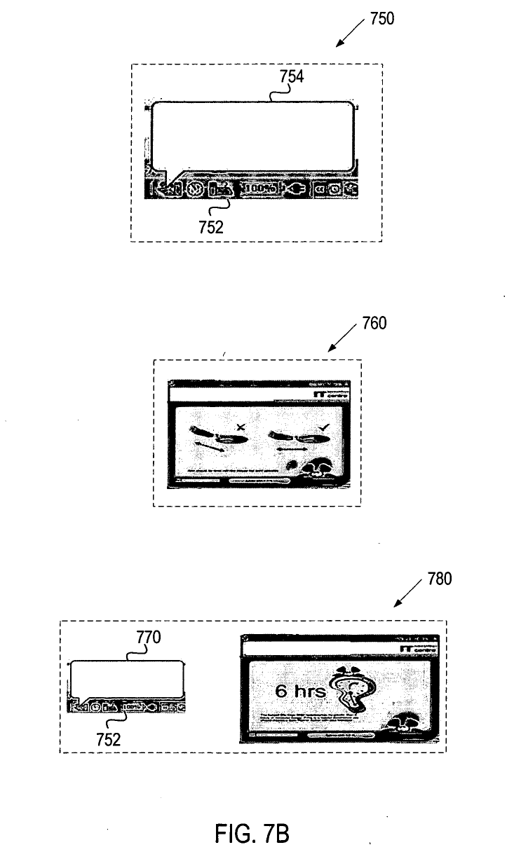

FIG. 7A is a flow diagram of an alternative embodiment of an automated feedback generation process 700. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 700 is performed by an ergonomic tool 110 of FIG. 1.

Referring to FIG. 7A, process 700 begins with processing logic tracking mouse usage events and keyboard usage events (processing block 702) and calculating PC usage parameters (processing block 704). The PC usage parameters may include, for example, the frequency of mouse interaction events between breaks, the frequency of keyboard interaction events between breaks, the frequency of both mouse and keyboard interaction events between breaks, the length of PC usage between breaks, the length of breaks, etc.

At processing block 706, processing logic compares the PC usage parameters with thresholds. Each threshold may be associated with a predefined condition concerning one or more PC usage parameters. For example, a first threshold condition may require that a user have activity (mouse or keyboard interaction) every 30 seconds for 20 minutes. A second threshold condition may require that a user have activity every 30 seconds for 35 minutes. A third threshold condition may require that a user have activity every 5 minutes for 60 minutes. A third threshold condition may require that a user have activity for 720 thirty-second periods (non-consecutive) representing 6 hours usage.

At processing block 708, processing logic generates an alert when a corresponding threshold condition is met. An alert may be displayed in a popup window. Although not intrinsically linked, the alerts may often be related to how the taskbar icons illustrate the PC usage. Different alerts may be displayed depending on different threshold conditions that have triggered the individual alerts.

FIG. 7B illustrates exemplary alerts that may be generated when threshold conditions discussed above are met. For example, the first threshold condition discussed above may trigger an alert 750 represented by a message in a speech bubble 754 coming out of the mouse icon indicator on the taskbar 752. An exemplary message may be as follows: “Hard at work? You have been working on your PC now for 20 minutes non-stop (not even 30 seconds). Why not take a 2-minute break and stretch? You know it will do you good.”

The second threshold condition discussed above may trigger a different message in the speech bubble 754. For example, the message triggered by the second threshold condition may be as follows:
“Busy day? You have now been working on your PC for 35 minutes non-stop (not even 30 seconds). Doesn't a break sound good about now?”

The third threshold condition discussed above may trigger an alert 760 represented by a popup dependent on usage profile. The illustrated alert 760 is a mouse related popup that may be generated when the user's mouse usage is more significant than keyboard usage. If more keyboard usage, a keyboard or posture related popup may be generated.

The fourth threshold condition discussed above may trigger a popup 780 and a message in a speech bubble 770 coming out of the mouse icon indicator on the taskbar 772. An exemplary message may be as follows:

“High Usage Days are not a very frequent occurrence and if these are being repeated may be you should review your daily PC usage routine or consult with your manager.”

As discussed above, feedback (e.g., statistics and historical data) on PC usage may be provided to a user in response to a user request. FIG. 8 is a flow diagram of one embodiment of a process 800 for providing PC usage statistics and historical data to a user. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 800 is performed by an ergonomic tool 110 of FIG. 1.

Referring to FIG. 8, process 800 begins with processing logic sending interactive data pertaining to user interactions with the mouse and the keyboard to a server (processing block 802). The interactive data may be sent once a day or with some other frequency (e.g., every 12 hours, every hour, etc.). In one embodiment, the interactive data is also stored in a local cache for a limited period of time (e.g., for 2 days). In one embodiment, processing logic sends the interactive data to the server using the UUID assigned to the user, i.e., without revealing the identity of the user. In addition, in one embodiment, to further protect privacy of the user, all communications with the server are initiated by the client application (e.g., on an hourly basis) while connected.

At processing block 804, processing logic receives a user request for PC usage statistics and/or historical data. The user request may be received when the communication begins as a background activity. In one embodiment, the user request may be generated when the user clicks an indicator icon on the taskbar. Alternatively, the user request may be generated when the user opens the ergonomic tool application.

At processing block 806, processing logic displays the PC usage statistics and/or historical data to the user. In one embodiment, the PC usage statistics and historical data are retrieved from the local cache and personal database files that have previously received this data from the server.

In one embodiment, the PC usage statistics and historical data are presented to the user via a set of user interfaces (UIs). FIG. 9A through 9E illustrate exemplary UIs used to present PC usage statistics and historical data to a user.

Referring to FIG. 9A, UI 900 includes tabs 902 through 912, with tab 902 being selected to view PC usage data. UI 900 presents user mouse clicks 914, keystrokes 916 and mouse/keystroke ratio 918 by week, day and hour relative to site and groups. A desired group may be selected by a user from a drop down box 958. UI 950 also allows user access to the online analytical processing (OLAP) cube or analyses of the database data in Excel (e.g., button 960). In addition, UI 950 may include an update box 962 to allow the database administrator to send messages related to ergonomic or other matters to all users.

Referring to FIG. 9B, UI 920 is displayed when tab 922 is selected. UI 920 presents keyboard shortcut usage analyses 928 and shows keyboard shortcut usage 924 per application (e.g., 19 specific shortcuts tracked across the 5 most used applications).

Referring to FIG. 9C, UI 930 is displayed when tab 932 is selected. UI 930 presents a list of software applications 936, and user mouse clicks, keystrokes and mouse movement 934 by software application relative to groups and site. As shown, the time and type of display may be selectable.

Referring to FIG. 9D, UI 950 is displayed when tab 952 is selected. UI 950 shows mouse clicks and keystrokes per week 956, and presents the user's mouse to keyboard ratio 954 against high usage days relative to site and groups. UI 950 also shows the percentile distribution for the metrics recorded (clicks, keystroke, high usage and mouse movement).

Referring to FIG. 9E, UI 970 is displayed when tab 972 is selected. UI 970 allows a user to make a selection 974 as to whether his or her PC usage data should be sent to a server. If the user selects the send data option, the user can also use a subscription and group management 980 to create a user group or subscribe to a work group, allowing the user data to be viewed as part of a work group. UUID 976 is assigned to the user. In order to protect the user's privacy, the user name is not associated with the UUID, and all data is viewable by UUID only.

Referring to FIG. 9F, UI 990 is displayed when tab 992 is selected. Ul 990 allows a user to view the Privacy Statement, Readme documentation and access links where they can learn more about the ergonomic tool.

Accordingly, embodiments of the present invention encourage alternative computer usage by promoting less mouse usage, more keyboard shortcuts and a higher awareness of computer usage patterns.

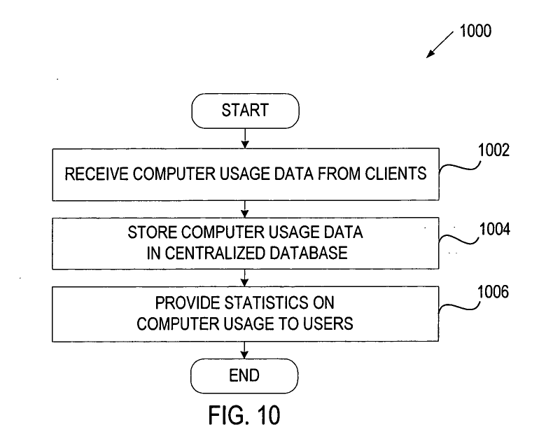

FIG. 10 is a flow diagram of one embodiment of a process 1000 for managing PC usage data of various users. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 1000 is performed by a computer usage management system 104 of FIG. 1.

Referring to FIG. 10, process 1000 begins with processing logic receiving PC usage data from multiple clients (processing block 1002). The PC usage data pertains to user interactions with the mouse and the keyboard. In one embodiment, the received data is associated only with the UUID of a relevant user and does not reveal the identity of the user. In addition, in one embodiment, to further protect privacy of the users, all communications between the clients and the server are initiated by the client application (e.g., on an hourly basis) while connected.

At processing block 1004, processing logic stores the PC usage data in a centralized database. The PC usage data may be stored in different groups (e.g., today's data, 25-day data and 75-day data).

At processing block 1006, processing logic provides PC usage statistics and historical data to users. In one embodiment, the PC usage statistics and historical data are periodically sent to local caches and database files (e.g., .dat files) _{[ml]} of individual client devices. In addition, the PC usage statistics and historical data may be presented to a user in response to a user request. Users may view PC usage statistics and historical data by any UUID through the OLAP. Users may also be allowed to delete all the data relating to their UUID stored in the centralized database at any time.

The PC usage statistics and historical data may contain important information not only for individual users but also for groups and organizations. It can be used, for example, to evaluate UI designs of various applications (e.g., whether they require a high mouse usage), identify high risks of ergonomic injury, and re-distribute work load to reduce the risk.

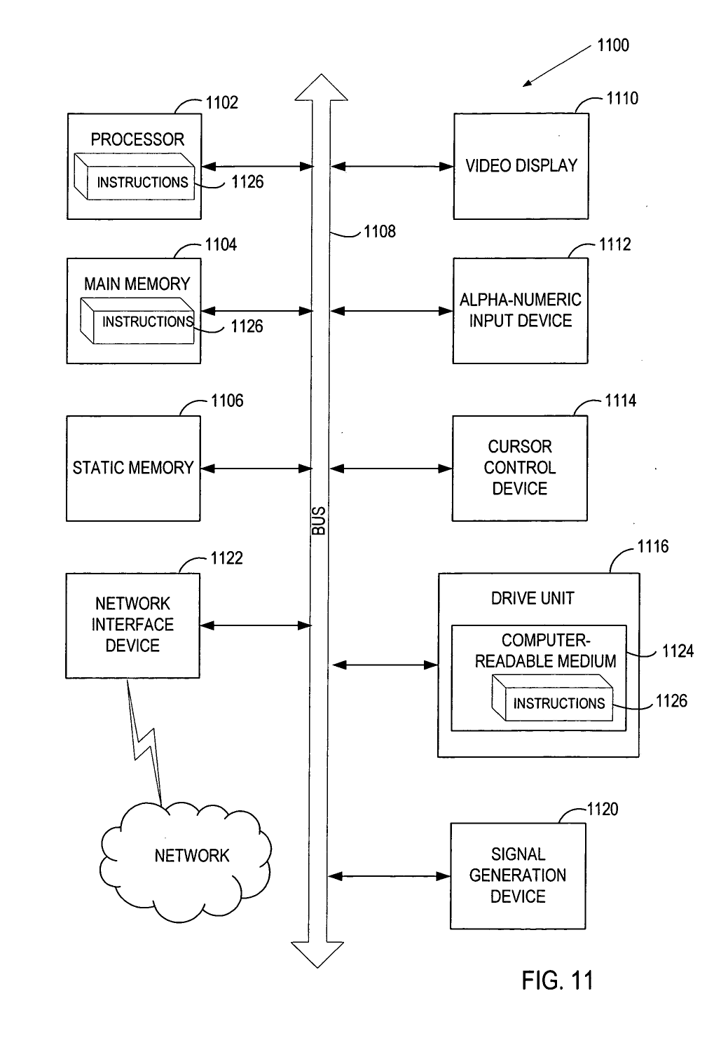

FIG. 11 shows a diagrammatic representation of machine in the exemplary form of a computer system 1100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processor 1102 (e.g., a central processing unit (CPU), a graphics processing unit (GPU) or both), a main memory 1104 (e.g., read only memory (ROM), flash memory, dynamic random access memory (DRAM) such as synchronous DRAM (SDRAM) or Rambus DRAM (RDRAM), etc.) and a static memory 1106 (e.g., flash memory, static random access memory (SRAM), etc.), which communicate with each other via a bus 1108.

The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1120 (e.g., a speaker) and a network interface device 1122.

The disk drive unit 1116 includes a machine-readable medium 1124 on which is stored one or more sets of instructions (e.g., software 1126) embodying any one or more of the methodologies or functions described herein. The software 1126 may also reside, completely or at least partially, within the main memory 1104 and/or within the processor 1102 during execution thereof by the computer system 1100, the main memory 1104 and the processor 1102 also constituting machine-readable media.

The software 1126 may further be transmitted or received over a network 1128 via the network interface device 1122.

While the machine-readable medium 1124 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and apparatus for facilitating safer computer usage of individual users in a distributed computing system have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computerized method comprising:
collecting data pertaining to user interactions with a cursor control device and a keyboard during a usage of a computing device by a user; and
providing a feedback to the user based on the collected data, the feedback concerning the usage of the computing device by the user.

2. The method of claim 1 wherein:
the user interaction with the cursor control device comprises user movements of a mouse and user clicks of a mouse; and
the user interaction with the keyboard comprises keystrokes.

3. The method of claim 1 further comprising:
comparing the collected data with one or more thresholds.

4. The method of claim 1 wherein collecting data pertaining to the user interactions with the cursor control device and the keyboard comprises:
tracking interactive events initiated by the user interaction with the cursor control device and the keyboard;
recording each of the interactive events and a time for said each of the interactive events; and
identifying an application associated with each of the interactive events.

5. The method of claim 4 wherein collecting data pertaining to the user interactions further comprises:
tracking individual character strings within the application; and
tracking missed and taken shortcuts by type and application.

6. The method of claim 1 further comprising:
sending the collected data to a server if requested by the user.

7. The method of claim 5 wherein the collected data is sent to the server without revealing an identity of the user.

8. The method of claim 1 wherein the feedback is provided in at least one of a popup window, a set of icons on a taskbar, and an independent window.

9. The method of claim 8 wherein the set of icons on the taskbar comprises a first icon, a second icon and a third icon, wherein the first icon indicates a continual usage of the computing device by the user since a last break of a predefined length, the second icon indicates an amount of keyboard usage since the last break of the predefined length, and the third icon indicates an amount of mouse usage since the last break of the predefined length.

10. The method of claim 8 wherein the popup window displays information concerning a current pattern of the usage of the computing device by the user and a recommendation to change the current pattern.

11. The method of claim 8 wherein the independent window displays at least one of a plurality of summary usage screens, wherein the plurality of summary usage screens comprises
a first screen presenting a user clicks, keystrokes and ratio over a predefined time period relative to site and groups,
a second screen presenting a user usage of keyboard shortcuts over a predefined time period,
a third screen presenting the user interactions by software application used relative to site and groups, and
a fourth screen presenting mouse clicks and keystrokes over a predefined time period, a percentile over a predefined time period, and a user mouse to keyboard ratio against high usage days relative to site and groups.

12. A computerized method comprising:
receiving user interaction data from a plurality of client devices, the user interaction data pertaining to interactions with a cursor control device and a keyboard by a user of each of the plurality of client devices;
storing the user interaction data in a centralized database; and
providing statistics to users of the plurality of client devices, the statistics concerning a usage of the plurality of client devices by the users.

13. The method of claim 12 wherein the user interaction data does not reveal an identity of the user.

14. The method of claim 12 wherein:
the user interaction with the cursor control device comprises user movements of a mouse and user clicks of a mouse; and
the user interaction with the keyboard comprises keystrokes.

15. The method of claim 14 wherein the user interaction data comprises information selected from the group consisting of a number of mouse clicks and keystrokes performed by the user over a predefined time period, a shortcut statistics associated with the user over a predefined time period, and a client device usage per application.

16. An apparatus comprising:
an interactive data collector to collect data pertaining to user interactions with a cursor control device and a keyboard during a usage of a computing device by a user; and
a feedback provider to provide a feedback to the user based on the collected data, the feedback concerning the usage of the computing device by the user.

17. The apparatus of claim 16 wherein:
the user interaction with the cursor control device comprises user movements of a mouse and user clicks of a mouse; and
the user interaction with the keyboard comprises keystrokes.

18. The apparatus of claim 16 further comprising an interactive data analyzer to compare the collected data with one or more thresholds.

19. The apparatus of claim 16 wherein the interactive data collector is to collect data pertaining to the user interactions by tracking interactive events initiated by the user interaction with the cursor control device and the keyboard, recording each of the interactive events and a time for said each of the interactive events, and identifying an application associated with each of the interactive events.

20. The apparatus method of claim 19 wherein the interactive data collector is further to collect data pertaining to the user interactions by tracking individual character strings within the application, and tracking missed and taken shortcuts by type and application.

21. The apparatus of claim 16 further comprising a tool manager to send the collected data to a server if requested by the user, the collected data being sent to the server without revealing an identity of the user.

22. The apparatus of claim 1 wherein the feedback provider presents the feedback in at least one of a popup window, a set of icons on a taskbar, and an independent window.

23. A machine-readable medium containing instructions which, when executed by a processing system, cause the processing system to perform a method, the method comprising:
collecting data pertaining to user interactions with a cursor control device and a keyboard during a usage of a computing device by a user; and
providing a feedback to the user based on the collected data, the feedback concerning the usage of the computing device by the user.

24. The machine-readable medium of claim 23 wherein:
the user interaction with the cursor control device comprises user movements of a mouse and user clicks of a mouse; and
the user interaction with the keyboard comprises keystrokes.

25. The machine-readable medium of claim 23 wherein the method further comprises comparing the collected data with one or more thresholds.

26. A system comprising:
a synchronous dynamic random access memory (SDRAM) to store data pertaining to user interactions with a cursor control device and a keyboard; and
a processor, coupled to the SDRAM, to collect the data pertaining to user interactions with the cursor control device and the keyboard during a usage of a computing device by a user, and to provide a feedback to the user based on the collected data, the feedback concerning the usage of the computing device by the user.

27. The system of claim 26 wherein:
the user interaction with the cursor control device comprises user movements of a mouse and user clicks of a mouse; and
the user interaction with the keyboard comprises keystrokes.

28. The system of claim 26 wherein the processor is further to compare the collected data with one or more thresholds.
